(19) United States
(12) Patent Application Publication
(10) Pub. No.: US 2014/0013664 A1
(43) Pub. Date: Jan. 16, 2014

(54) Vertical Farming Turbine

(71) Applicant: Supawadee Mem Tesin, E. Lansdowne, PA (US)

(72) Inventor: Supawadee Mem Tesin, E. Lansdowne, PA (US)

(21) Appl. No.: 13/549,450

(22) Filed: Jul. 14, 2012

(51) Int. Cl. A01G 31/02

(52) U.S. Cl. 47/62 R

(57) ABSTRACT

A ferrous wheel framework will be used to grow farming crops. This vertical farming method allows for less land usage, less machinery, less water usage, fewer pesticides and provides a new form of renewable energy.

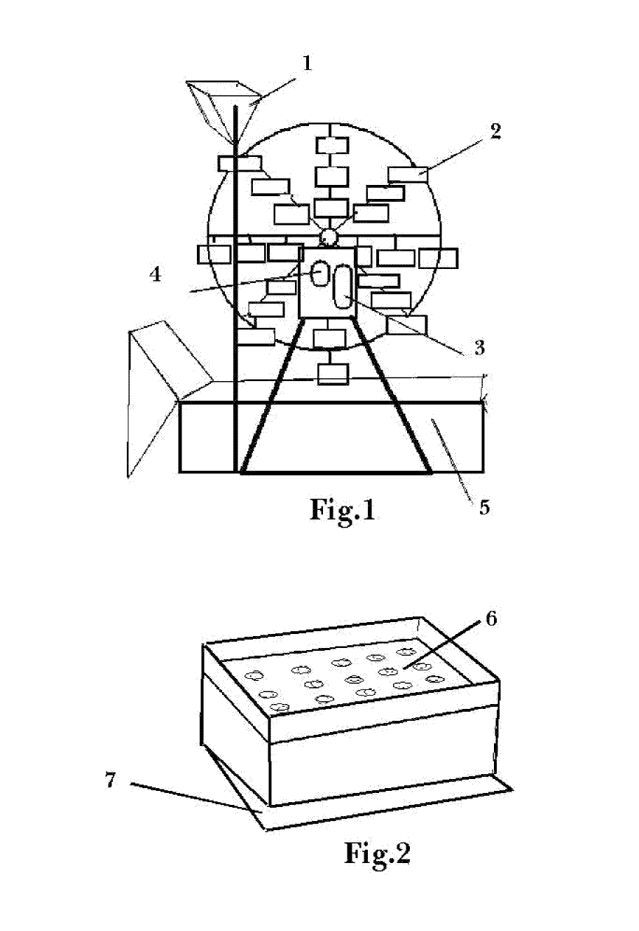

### BACKGROUND OF THE INVENTION

The Vertical Farming Turbine (VFT) combines hydroponic farming with the technology of a wind turbine. The VFT addresses the increased global demand for sustainable farming and clean energy alternatives in one mechanism.

### SUMMARY OF THE INVENTION

The present invention relates to a vertical farming method and energy generator, particularly the method of growing hydroponic crops on a rotating wheel which generates electricity. This method of farming uses less land, water and pesticides; therefore, the VFT is a more sustainable farming method which will lead to healthier crops, water conservation and less deforestation. Because the VFT generates electricity for extra income to the farmer, healthy foods can be made more affordable to people.

I claim:

1. A wheel frame suspending hydroponic plant trays where water is released from the top of the wheel onto the plant trays and drains down onto the underlying trays and lower reservoir to be recycled, thereby, providing water and nutrients to the plants and creating kinetic energy to rotate the main wheel which is attached to a motor.
